(19) United States
(12) Patent Application Publication
(10) Pub. No.: US 2020/0136356 A1
(43) Pub. Date: Apr. 30, 2020

(54) METHOD AND SYSTEM FOR THE AUTOMATED SUPPORT OF A CONNECTION PROCESS, IN PARTICULAR OF COMPONENTS ARRANGED IN A CONTROL CABINET OR ON A MOUNTING SYSTEM

(71) Applicant: RITTAL GMBH & CO. KG, Herborn (DE)

(72) Inventors: Jan Henry SCHALL, Lollar (DE); Thomas WEICHSEL, Erkelenz (DE)

(21) Appl. No.: 16/606,694

(22) PCT Filed: Mar. 23, 2018
(86) PCT No.: PCT/DE2018/100267

§ 371 Date: Oct. 18, 2019

(30) Foreign Application Priority Data
Apr. 21, 2017 (EP) 17167566.3

(51) Int. Cl. H02B 3/00; H02B 1/04

(52) U.S. Cl. CPC H02B 3/00; H02B 1/04

(57) ABSTRACT

The invention relates to methods for automated support of a connection process, in particular of a wiring process, preferably of components arranged in a switch cabinet or on an assembly system, in which an identifier of a connecting line is detected by means of a detection device, wherein the identifier identifies the connecting line, in which a visual user output is automatically generated depending on the detected identifier and a connection plan, in particular a wiring plan, the visual user output concerning the connecting, in particular concerning the wiring, of the connecting line identified by the identifier and in which the generated user output is delivered via an output device. The invention also concerns a system for automated support of a connection process, a detection unit for detecting an identifier of a connecting line, uses thereof and a computer program.

### CROSS-REFERENCE TO RELATED APPLICATIONS

This application is a 371 U.S. National Phase of International Application No. PCT/DE2018/100267, filed on Mar. 23, 2018, which claims the benefit of European Application No. 17167566.3, filed on Apr. 21, 2017. The entire disclosures of the above applications are incorporated herein by reference.

### BACKGROUND

This section provides background information related to the present disclosure which is not necessarily prior art.

### TECHNICAL FIELD

The invention concerns a method for the automated support of a connection process, in particular a wiring process, in particular of components arranged in a switch cabinet or on an assembly system. Furthermore, the invention concerns a system for the automated support of a connection process, in particular a wiring process of components arranged in a switch cabinet or on an assembly system, in particular to carry out the procedure described above. The invention also concerns a detection unit for detecting an identifier of a connecting line, uses of the system and the detection unit, and a computer program.

### DISCUSSION

Switch cabinets are primarily used to supply systems or electrical installations with electrical energy and sometimes also with signals, for example to control a system or electrical components. For this purpose, a switch cabinet typically contains a large number of electrical, electronic and partly also pneumatic or hydraulic components. In addition, other electrical and electronic components can also be installed in or on a switch cabinet, for example for air conditioning, lighting or monitoring the switch cabinet.

In order to function properly, the components housed in the switch cabinet must be connected to each other via connecting lines in accordance with a specified connection plan, e.g. a wiring plan, a tubing plan, a piping plan or a combination thereof, whereby the requirements for the individual connecting lines may differ depending on the type of connection, e.g. because the lines must be configured for different current intensities, operating frequencies, cross-sections or for the transmission of data. Wiring plans are used in particular to connect electrotechnical components; hose and piping plans are used in particular for connecting pneumatic or hydraulic components.

A switch cabinet can be equipped with the corresponding components either at the factory or directly at the place of use. The connection, in particular the wiring of the components, can also be carried out at the factory or directly at the place of use and is carried out manually by a technician. The extension or modification of existing control cabinets also requires manual wiring, tubing or piping by a technician, in particular an electrical engineer, if factory wiring, tubing or automated tubing is not possible in such cases.

There are different procedures for manual wiring/tubing/piping of switch cabinets and mounting systems for switch cabinets, such as mounting plates.

The technician carrying out the wiring/tubing/piping can, for example, determine the individual connections to be made on the basis of the information in a given circuit diagram and with his know-how, locate the associated connection points in the control cabinet, select connection lines suitable for the individual connections, in particular with suitable cross-sections or made of suitable materials, and thus carry out the wiring/tubing/piping.

Alternatively, the technician can also proceed according to a so-called wiring, tubing and/or piping list, in which the wiring/tubing/piping to be carried out is already specified and listed. The technician can then work through the connections listed in the wiring, tubing and/or piping list one after the other by using his know-how to manually locate the respective connection points of the individual wiring systems, determine the installation routes and then carry out the wiring/tubing/piping accordingly.

There are also various procedures for manufacturing the connection lines required for wiring/tubing/piping:

The technician can use his know-how to select the type of connecting line required for each connection and manufacture (assemble) the corresponding connecting lines on site during the connection process. For the production of the connecting lines, he can in particular cut the connecting lines to length and finally assemble them, e.g. by applying wire end treatments and/or labels.

Alternatively, the connecting lines can also be defined and pre-assembled automatically or manually before the technician has to carry out the wiring/piping/tubing. For this purpose, for example, a so-called virtual routing can be carried out during work preparation before the actual wiring/piping/tubing, in which the wiring/tubing/piping of the switch cabinet, preferably software-supported, is already pre-planned in detail, so that the following can be done such that each connecting line is defined in advance with length, type of connection, type of assembly and, if applicable, type of labelling. In particular, with such virtual routing, the routing routes can be defined in advance and, if necessary, stored in a data format (such as CAx format).

Pre-assembly of the connecting line and pre-definition of the laying routes considerably simplify the wiring/tubing/piping of a switch cabinet, as the technician does not have to select the type of connecting line himself, does not have to assemble the connecting lines himself and preferably does not have to determine the laying routes himself.

Due to the complexity of today's switch cabinets and the large number of connections to be made within the control cabinets, however, even with prefabricated connecting lines there is the problem for the technician of correctly identifying the individual prefabricated connecting lines, locating the components to be connected, identifying the connection points on the components intended for the connecting lines, determining the respective installation route and then laying and connecting the connecting line in real terms as intended. Particularly in complex switch cabinets with many components and connections, mix-ups occur time and again, so that the technician cannot complete the installation properly or incorrect connections are made, which can lead to faulty function or even damage to components during operation.

### SUMMARY

This section provides a general summary of the disclosure, and is not a comprehensive disclosure of its full scope or all of its features.

Against this background, it is the aspect of the present invention of providing a process and a system with which, in particular, such a wiring process can be effectively supported, so that wiring is facilitated for the technician, miswiring is avoided and the wiring process as a whole is accelerated with increased quality.

This problem is solved by a method for the automated support of a connection process, in particular of a wiring process, preferably of components arranged in a switch cabinet or on an assembly system, in which an identifier of a connecting line is detected by means of a detection device, wherein the identifier identifies the connecting line, in which a visual user output is automatically generated depending on the detected identifier and a connection plan, in particular a wiring plan, the visual user output concerning the connecting, in particular concerning the wiring, of the connecting line identified by the identifier and in which the generated user output is delivered via an output device.

The above problem is further solved according to the invention by a system for the automated support of a connection process, in particular a wiring process, of components arranged in a switch cabinet or on an assembly system, in particular for carrying out a process as described above, having a detection device configured to detect an identifier of a connecting line, wherein the identifier identifies the connecting line, having a visualization device which is configured to generate a visual user output depending on the detected identifier and a connection plan, in particular a wiring plan, concerning the connecting, in particular concerning the wiring, of the identified connection line, and having an output device configured to deliver the user output generated by the visualization device to a user.

The method described above shall preferably be executed using such a system. Accordingly, such a system shall preferably be used to execute the method described above.

The method described above and the system described above each serve to automatically support a connection process. A connection process or the connection of components arranged in a switch cabinet or on an assembly system is understood to mean the connection of connecting lines to or between the components which are connected in a switch cabinet or on an assembly system. The assembly system may be arranged in or intended for a switch cabinet. Alternatively, it can also be an independent assembly system that can also be used without a switch cabinet, for example directly on a machine.

In particular, the connection process can be a wiring process in which connecting lines for wiring, such as single wires or cables are connected. However, it is also conceivable that connecting lines for pneumatic or hydraulic components, such as hoses or pipes, could be connected. When connecting tubes, this can be referred to as a tubing process and when connecting pipes as a piping process. Basically, the term connection process covers wiring processes, tubing processes, piping processes and combinations thereof.

Although the connection process itself is performed manually by a technician, it is supported automatically by the method or system described above. In particular, the method and the system help the technician to clearly assign the pre-assembled connecting lines, to identify the associated connection points and preferably also to adhere to a specified routing route by the method and the system providing the technician with the necessary information specifically for the next connecting line selected by him.

The connection process, in particular the wiring process, is carried out in particular on components arranged in a switch cabinet or on a mounting plate.

A switch cabinet is understood to be a device for accommodating electrotechnical, hydraulic and/or pneumatic components. The switch cabinet forms an enclosure to protect the components, in particular from external influences and, if necessary, from view. In addition, such an enclosure preferably enables targeted heat dissipation from the components installed in it. Mounting systems are usually used to mount these components. They are called mounting plates or mounting frames and are installed in the switch cabinet. The components are mechanically fastened to these mounting systems. Furthermore, mounting systems can also be used independently of a switch cabinet.

The switch cabinet preferably has a cabinet door through which the inside of the enclosure can be accessed so that the components can be assembled and connected.

The components are in particular components of the control technology. In particular, the switch cabinet can be a switch cabinet for electrotechnical components and, if necessary, additional hydraulic and/or pneumatic components. However, the switch cabinet can also be designed exclusively for hydraulic and/or pneumatic components.

A mounting system is a system that is used to install components in a switch cabinet or independently of it. The mounting system can be, for example, a mounting frame or a mounting plate. A mounting plate is a plate that is used for arrangement and mechanical fastening within a switch cabinet. The components arranged on a mounting plate are then connected to each other via suitable electrical, pneumatic or hydraulic connections. For the purpose of mounting, the mounting plate preferably has mounting means such as holes or rails on which the electrical and electronic components can be mounted. In particular, such a mounting plate can form part of a switch cabinet.

In this method, a detection device is used to detect a connection line identifier. The identification is preferably acquired optically, for example by means of a camera or a scanner, for example a laser scanner. Accordingly, the detection device of the system preferably has a camera or a scanner, for example a laser scanner. The identifier can, for example, simply be printed on a connecting line, which makes it very easy and inexpensive to produce the identifier.

A connection line identifier is an identifier that is assigned to a specific connection line. The identifier is preferably attached directly to the connecting line, e.g. printed on it. The identifier can, for example, be a barcode or QR code. Alternatively, the identifier can also be a character string, for example from numbers, letters and/or other symbols which are captured by the detection device and which can be recognized, for example, by an image analysis method known per se. For example, the identifier may be a numeric or alphanumeric code, possibly with special characters.

The identifier identifies the connection line. This means that the connecting line can be distinguished from other connecting lines by the identifier. The identifier is preferably chosen so that it uniquely identifies the connecting line within a set of several connecting lines for connecting, in particular for wiring, components arranged in a switch cabinet or on a mounting system, for example a mounting plate. If a large number of connecting lines are provided for connecting components arranged in a switch cabinet or on an assembly system, e.g. a mounting plate, especially for wiring, the identifiers of the individual connecting lines therefore preferably differ from one another, so that each individual connecting line can be uniquely identified on the basis of its identifier. If the quantity of connecting lines for connection, in particular for wiring components arranged in a switch cabinet or on a mounting system, e.g. a mounting plate, comprises several connecting lines of the same type and length, these may also have the same or parts of the same identifiers in one design.

The visualization device of the system arranged to generate a visual user output about the connection of the connecting line identified by the identifier depending on the detected identifier and a connection plan. Accordingly, the visualization device of the system is configured to generate a visual user output concerning the connection of the connection line identified by the identifier, depending on the detected identifier and a connection diagram. For example, the wiring plan may be a wiring plan and the visualization device may be configured to generate a visual user output concerning the wiring of the connection line identified by the identifier, depending on the identifier detected in the wiring plan.

A user output concerning the connection, in particular the wiring, of the connecting line identified by the identifier is understood to mean a user output containing instructions for the connection, in particular the wiring, of the identified connecting line. The instructions for connection, in particular for wiring, are preferably at least partially in graphical form. In particular, the user output may include a graphical depiction of the connection points of the connecting line and/or the laying route of the connecting line.

To generate the user output, a visualization software is preferably used, which is stored, for example, on a memory of the system and is based on at least one processor of the visualization device can be executed. In particular, a virtual model of the switch cabinet with the components to be connected arranged therein or of the assembly system with the components to be connected arranged thereon can also be stored on a memory of the system, on the basis of which the visualization software generates the visual user output.

The user output concerning the connection, in particular the wiring, is generated depending on the detected identifier. In this way, the user output can be specifically adapted to the connection line identified by the identifier, so that the user receives specific instructions for connecting, in particular for wiring, the connection line selected by him.

The user output is furthermore generated depending on a connection plan. A connection plan is a diagram which assigns information to the individual connection lines for their connection, in particular the connection points of the respective connection line and/or the routing path of the respective connection line. The connection plan can, for example, be stored in a memory of the system so that it can be called up by the visualization device. In particular, the connection plan may be a wiring diagram which assigns information for the wiring of the individual connecting lines. Furthermore, the connection plan can also be a wiring diagram and/or a piping diagram which assigns information for the connection of the individual connection lines, in particular through hoses and/or pipes, to the individual connection lines. The connection plan can also be a combination of a wiring plan, a piping plan and/or a piping plan.

The connection plan, in particular the wiring diagram, can, for example, be stored in the form of a virtual model, in particular a two- or three-dimensional model, of the switch cabinet or the mounting plate, which comprises, on the one hand, information about the switch cabinet (or about the mounting plate) and the components arranged therein (or thereon) and, on the other hand, information about the pre-assembled connecting lines for connecting the individual components, in particular the respective connection points and the respective routing path of the connecting lines.

The user output is delivered via an output device. The output device is preferably a screen, a projector, data glasses or a combination of a screen, a projector and/or data glasses. In particular, the output device may also be a screen of a mobile device such as a smartphone or tablet computer.

With the described method and system, a technician can, after selecting a connection line, have its identifier automatically detected and then install the relevant connection line using the user output issued by the output device.

The above problem is further inventively solved by a detection unit for detecting an identifier of a connecting line having a detection area in which a connecting line to be identified can be positioned, further having a camera module configured to receive image data from a connecting line positioned in the detection area, further having a controlling device configured to find an identifier of a connecting line in the received image data and to generate a digital code for the found identifier, and furthermore having a transmission device configured to transmit the digital code for the found identifier to a visualization device for generating a user output concerning the connection, in particular concerning the wiring, of the connecting line identified by the identifier.

The detection area shall preferably include a receptacle into which a connecting line to be identified can be inserted. In this case, the camera module is preferably set up to capture image data from a connection line inserted into the receptacle. The receptacle is preferably designed to at least partially surround a section of the connecting line. For example, the receptacle can be in the form of a duct into which the connecting line can be inserted or pushed. The duct can, for example, be open on one or both sides. The receiving device is preferably dimensioned in such a way that it enables an identifier to be detected at various positions on the connecting line, for example at the end of the wire, continuously along the wire or at a specific point on the connecting line, for example at a specific distance from the end of the wire.

The detection unit further comprises a camera module arranged to detect image data from a connection line positioned in the detection area, in particular a connection line inserted into the preferably intended receptacle. For this purpose, the camera module is arranged in particular in the area of the receptacle. If, for example, the receptacle is in the form of a duct, the camera module is preferably located within the duct or on the duct wall. Preferably the image has a characteristic, such as an edge, which is arranged in the field of view of the camera module. This makes it easier to position the connecting line in the receptacle to position the identifier in the field of view of the camera module.

Furthermore, the detection unit preferably has a screen on which the image data detected by the camera module are output. This facilitates the positioning of the connecting line in the receptacle so that the identification can be captured by the camera module.

In order to capture the image data as independently as possible from changing environmental conditions such as the lighting conditions at the location of the detection unit and to be able to reliably recognize the identification of a connecting line, the detection unit preferably has a lighting device that illuminates the field of view of the camera module. If the receptacle is in the form of a duct, the lighting device shall preferably be located within the duct or on the duct wall.

The lighting device is preferably configured and arranged to uniformly illuminate a curved surface on a connecting line such as a cable, pipe or hose. In this way, an identifier printed on the connecting line can be reliably detected. The lighting device is preferably designed and arranged in such a way that a connecting line can be uniformly illuminated transversely to its direction of extension over an angle range of at least 180°, preferably at least 270°. In particular, the lighting device may at least partially surround the preferably provided receptacle or be arranged on several sides of the receptacle.

The detection unit further comprises control means arranged to detect a connection line identifier in the detected image data. For this purpose, the control device may in particular comprise at least one processor and a memory with a program for analyzing image data, the execution of which on the at least one processor initiates an image analysis of the image data captured by the camera module in order to find in the image data an identifier of a connection line, for example a character string such as a numerical code or a barcode or QR code.

The controller is also configured to generate a digital code for the found identifier. For example, if the image data includes an image of an identifier in the form of a character string (for example, image data of the character string “A38BX”) or a bar code or QR code, the controller is preferably arranged to generate a digital representation of the character string (for example, the digital character string “A38BX”) or the message encoded in the bar code or QR code. By this conversion of the image data into a digital code this can be can be digitally processed.

The detection unit further comprises a transmission means arranged to transmit the digital code for the detected identifier to a visualization means for generating a user output concerning the connection, in particular concerning the wiring, of the connecting line identified by the identifier. The transmission device may, for example, comprise a transmission device via which the digital code can be transmitted, for example via a standardized interface such as a network interface, with a digital transmission protocol to a server on which visualization software for generating a user output concerning the connection, in particular the wiring, of the connecting line identified by the identifier runs.

In one embodiment, a visualization unit is integrated into the detection unit, which is set up to generate a user output concerning the connection, in particular the wiring, of the connection line identified by the identifier. In this way the user output can be generated directly in the detection unit and preferably displayed on a user output device of the detection unit or on an output unit connected to the detection unit via a communication link, such as a data goggle or the like. In this case, the digital code can in particular be transmitted purely by software, for example by transferring a variable with the digital code for the identifier to a visualization module.

The detection unit can be configured as a stationary or mobile unit. Preferably, the detection unit comprises an enclosure which protects the individual components of the detection unit from environmental influences such as dust, moisture, humidity and the like. The preferably provided receptacle can in particular be formed by the enclosure, whereby a lighting device is then preferably integrated into the enclosure in order to uniformly illuminate a curved surface of a connecting line positioned in the receptacle.

The above problem is further solved, in accordance with the invention, by using the system or detection unit described above for automated support of a connection process, in particular a wiring process of components arranged in a switch cabinet or on a mounting system, such as a mounting plate.

The above-mentioned problem is further solved by a computer program comprising program instructions whose execution on at least one processor triggers the execution of the method described above. Such a computer program may, for example, be stored on a memory of the system or the detection unit so that it can be executed on the respective control device.

The different embodiments of the method, the system, the detection unit, the computer program and the uses are described below, each of which applies individually to the method, the system, the detection unit, the computer program and the uses, and each of which may also be combined.

In a first embodiment, an identifier of a connecting line from a set of pre-assembled connecting lines for connecting, in particular for wiring, components arranged in a switch cabinet or on a mounting system, e.g. a mounting plate, is detected. In particular, the system may comprise a set of pre-assembled connecting lines for connecting, in particular for wiring, components arranged in a switch cabinet or on a mounting system, e.g. a mounting plate, each connecting line having an identifier for identifying the respective connecting line.

The fact that the technician has a number of pre-assembled connecting lines available to him for connecting, in particular for wiring, components arranged in a switch cabinet or on an assembly system, e.g. a mounting plate, a quantity of pre-assembled connecting lines, in particular the wiring, of the components arranged in the switch cabinet or on the mounting plate, considerably simplifies the connection, in particular the wiring, since the technician does not have to determine and produce the type and length of the individual connecting lines himself. The method and system described here also overcomes the current state-of-the-art problem that with a large number of pre-assembled connecting lines for connection, especially for wiring components arranged in a switch cabinet or on a mounting system, e.g. a mounting plate, it is difficult for the technician to separate the individual connecting lines. By setting up the method and the system to support the connection, in particular the wiring, of components arranged in a switch cabinet or on a mounting system, e.g. a mounting plate, with pre-assembled connecting lines, by providing the technician with the information required for the connection, in particular for the wiring, of the individual connecting lines on demand, the technician can carry out the connection, in particular the wiring, of the components arranged in the switch cabinet or on the mounting plate much more easily.

The visualization device is preferably designed to generate visual user output about the connection, in particular the wiring of the individual connecting lines of the set of pre-assembled connecting lines. For this purpose, the connection plan, in particular the wiring plan, shall preferably include information on the connection, in particular on the wiring of the individual connecting lines, from the quantity of connecting lines, in particular about the respective connection points and/or the respective installation route.

In another embodiment, the user output is generated using a virtual model of the switch cabinet or assembly system with a depiction of the connection, in particular the wiring, of the identified connecting line. If the system is configured accordingly, the visualization device is set up to generate the user output with a depiction of the connection, in particular the wiring of the identified connecting line, by means of a virtual model of the switch cabinet or assembly system. In this way, the technician making the connection, in particular the wiring, can take from the user output instructions for connection, in particular the wiring of the identified connecting line, in an intuitive and graphical way, so that the connection, in particular the wiring, is simplified. For example, the user output can show a depiction of the switch cabinet or assembly system and the components arranged thereon with a depiction of the identified connecting line in the finished connected, in particular wired, position. The connection plan, in particular the wiring plan, can be formed at least in part by the virtual model of the switch cabinet or the assembly system. In addition, the connection plan, in particular the wiring plan, can include, for example, an assignment list in which a virtual model of the respective connection line is assigned to the identifiers for identifying the individual connection lines.

In another embodiment, the user output is provided via an augmented reality device, where a real image or a real object is superimposed with the generated user output. In a corresponding configuration, the system comprises an augmented reality device which is configured to provide user output to the user, whereby a real image or real object is superimposed with the generated user output. The augmented reality device is therefore the output device of the system.

An augmented reality device is a device that is configured to enhance a user's perception of reality with the aid of a computer. For this purpose, the augmented reality device can display a real image, for example an image taken by a camera, and superimpose it with additional information, for example in text and/or image form. The superposition of the real image with the additional information can be performed by the visualization device. Alternatively, the augmented reality device can project information, for example in text and/or image form, into the user's field of vision, for example on an at least partially transparent screen as in a head-up display or directly on the user's retina as in some data glasses.

Furthermore, the augmented reality device can also be set up to superimpose the user output on a real object, in particular the switch cabinet or the assembly system and/or the components arranged therein or thereon. For this purpose, the augmented reality device may, for example, have a projection unit which is set up to project the user output directly onto the real object, for example the switch cabinet or the assembly system and/or the components arranged therein or thereon. Preferably, the user output is projected onto the switch cabinet or the mounting system and/or the components arranged therein or thereon in such a way that the connection points and/or the routing path for the identified connecting line are displayed directly on the real switch cabinet or the real mounting system and/or the components arranged therein or thereon.

The augmented reality device is preferably a data goggle. This can be, for example, one or two screens to display the generated user output and the real image display or a projection unit to display the user output by projection onto the retina of the wearer. By wearing data goggles, the technician keeps his hands free for connection, especially the wiring of the switch cabinet or mounting plate.

Alternatively, the augmented reality device can be a smartphone or a tablet PC. Smartphones and tablet PCs usually have a screen and a camera, which can be used to detect an identifier for a connection line and to record a real image of the switch cabinet or mounting plate. Furthermore, today's smartphones and tablet PCs have sufficient computing power to generate a visual user output for the connection line identified by the detected identifier concerning the connection, in particular the wiring, of the connection line. Alternatively, the user output can also be generated on a server with which the augmented reality device communicates via a communication connection such as a network connection.

In a particularly preferred embodiment of the method, a real image of the switch cabinet or the assembly system and/or the components arranged therein or thereon is captured and superimposed with a virtual image of the switch cabinet or the assembly system and/or the components arranged therein or thereon and/or with a virtual image of the identified connecting line. With a corresponding embodiment of the system, the visualization device is arranged to superimpose a virtual image of the control cabinet or the assembly system and/or the components arranged therein or thereon on a real image of the control cabinet or the assembly system and/or the components arranged therein or thereon and/or a virtual image of the identified connecting line on the visualization device. In particular, the system has a detection device for detecting an image of the switch cabinet or the assembly system and/or the components arranged therein or thereon. For example, the detection device provided for detecting the identification can be used to detect a real image of the switch cabinet or the assembly system and/or the components arranged therein or thereon.

In particular, the real image is superimposed on the user output in such a way that a depiction of the identified connecting line is displayed in the real image of the switch cabinet or the assembly system and/or the components arranged therein or thereon, preferably at the position to be laid. In this way, the user can intuitively see immediately how the identified connection line is to be connected and laid.

In a further embodiment of the method, a user input is received via the connection made, in particular about the wiring of another connection line identified at an earlier point in time, and the user output regarding the connection, in particular the wiring of the identified connection line, is generated preferably depending on the user input regarding the connection made, in particular the wiring of the other connection line. With a corresponding embodiment, the system comprises an input device which is set up to receive user inputs about the connection made, in particular the wiring made, of previously identified connecting lines.

In another embodiment, the system has a controller configured to effect execution of the method described above or an embodiment thereof. For this purpose, the system comprises in particular a memory on which a computer program, in particular the previously described computer program, is stored, the execution of which on at least one processor of the control device causes the execution of the method.

In a further embodiment of the method, a virtual model of the switch cabinet or assembly system to be manufactured is generated, in particular with the components to be arranged in or on it, and the connection plan, in particular the wiring plan, is generated on the basis of the virtual model. In particular, the connection lines required for connecting the individual components, in particular for wiring, can be defined on the basis of the virtual model, for example with regard to their type, length and/or laying routes. The connection plan, in particular the wiring plan, is then preferably generated on the basis of the connection lines defined in this way. The connection plan generated in this way, in particular the wiring plan, can, for example, be stored in a memory of the system.

Furthermore, the connecting lines can be assembled on the basis of the definition of the connecting lines required for connection, in particular for wiring, so that a number of suitable pre-assembled connecting lines are available for connection, in particular for wiring, of the components arranged in the switch cabinet or on the assembly system.

The individual connection lines defined on the basis of the virtual model of the switch cabinet or the assembly system are assigned to the identifier identifying the respective connection line and can be applied directly to them, in particular printed, during the assembly of the respective connection lines. The connection plan, in particular the wiring plan, is preferably generated in such a way that the identifiers of the individual connection lines are assigned to the information for connection, in particular for wiring, of the respective connection lines. In this way, the information for connecting, in particular for wiring, a connection line for generating the user output as a function of the identifier can be retrieved from the connection plan, in particular the wiring plan.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further advantages and characteristics of the method, the system, the detection unit, the uses and the computer program can be found in the following description of embodiment examples, with reference to the attached drawing.

FIG. 1 shows a first embodiment of the system and the method;

FIG. 2 shows a second embodiment of the system and the method;

FIG. 3 shows an exemplary user output;

FIG. 4 shows a further embodiment of the system and the method and

FIG. 5 shows an embodiment of the detection unit.

### DETAILED DESCRIPTION

Example embodiments will now be described more fully with reference to the accompanying drawings.

The figures show systems and methods for automated support of a wiring process. However, the systems and methods may also be configured and designed to connect connection lines for pneumatic or hydraulic connections, i.e. in particular for the automated support of a piping or tubing process.

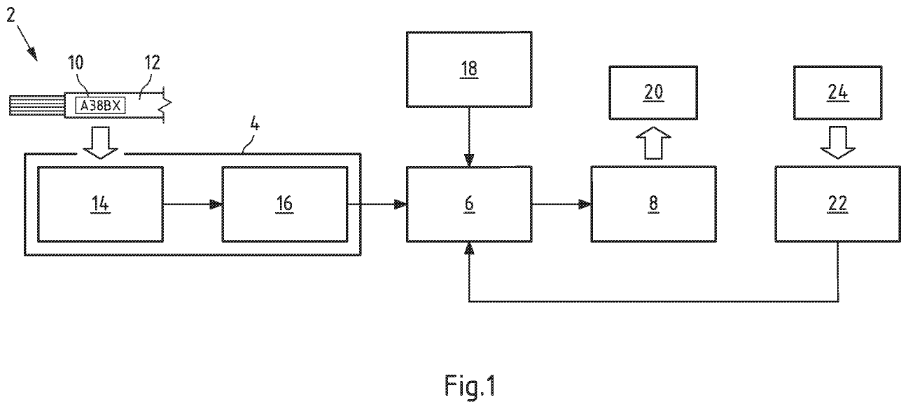

FIG. 1 shows a schematic representation of a first exemplary embodiment of the inventive system. System 2 for the automated support of a connection process of components arranged in a switch cabinet or on a mounting system, such as a mounting plate, comprises a detection device 4, a visualization device 6 and an output device 8.

The detection device 4 is set up to detect an identifier 10 of a connection line 12. For this purpose, the detection device 4 can, for example, have a camera 14 or alternatively a scanner such as a laser scanner. The processing device 16 examines the image data recorded with the camera 14 by means of image processing techniques for the presence of an identifier of a connection line and generates a digital code for the identifier found, so that the detected identifier in the form of the digital code can be further processed by the visualization device 6 to generate a user output.

The visualization device 6 is configured to generate a visual user output 20 regarding the connection, e.g. regarding the wiring, of the connection line 12 identified by the identifier 10, depending on the detected identifier and a connection diagram, e.g. a wiring diagram 18. For example, the wiring plan 18 can be stored in an electronic memory of system 2 and contains information about the respective connection points and laying routes of the connecting lines to be connected.

In order to generate the visual user output 20, the visualization device 6 retrieves the information about the connection, for example about the wiring, of the connection line 12 identified on the basis of the detected identifier 10 from the connection plan 18 and generates a corresponding graphic representation, for example with a schematic representation of the switch cabinet and a highlighted representation of the identified connection line 12 in the installed state.

The output device 8 is finally configured to emit the user output 20 generated by the visualization device 6 to a user. For this purpose, the output device 8 may, for example, have a screen.

The system 2 can also be configured to generate the user output 20 as augmented reality representation. For this purpose, the visualization device 6 can be used to generate the user output 20 by, for example, superimposing a picture of the switch cabinet captured by the camera 14 with the components to be connected, in particular the components to be wired, with a highlighted representation of the identified connection line 12 in the connected state.

The system 2 may also have an input device 22 arranged to receive user input 24 by connecting a previously identified connection line. In this way, the system 2 can log the connection actually made by the technician.

Visualization device 6 can also be configured to generate user output 20 by connecting the identified connection line, depending on the user input(s) received previously, by connecting connection lines. For example, the user output 20 can include a highlighted representation of the connection line 12 identified by the detected identifier 10 as well as representations of other connection lines for which user inputs 24 have already been received via their routing. This allows the user, for example, better orientation on the switch cabinet by determining the position of the new connecting line to be connected to the already connected connection lines 12 can be read from the user output 20.

The following is an example of how a technician can use the system 2 to connect, and in particular wire, components arranged in a switch cabinet with a lot of pre-assembled connecting leads, and be supported by the system 2. The example also includes an exemplary embodiment of the method for the automated support of a connection process, in particular the wiring process, of components arranged in a switch cabinet.

At the beginning of the connection process, the technician selects a connection line 12 from a quantity of pre-assembled connection lines with respective identifiers available to him for connecting components arranged in a switch cabinet and positions the identifier 10 on the selected connection line 12 in front of the camera 14 of the detection means 4, so that the detection means 4 detects the identifier 10 of the selected connection line 12 and generates a digital code for the identifier 10 which is passed to the visualization means 6.

The visualization device 6 uses the digital code for the identifier 10 from the connection plan 18 to retrieve information about the connection of the connection line 12 identified by the identifier 10 and uses this information to generate a user output 20, for example with a graphic representation of the switch cabinet and a representation of the identified connection line 12 in the connected state. The generated user output 20 is then output via the output device 8 so that the technician can extract the information necessary to connect the selected connection line 12 and perform the connection manually.

If the system 2 has an input device 22, the technician can enter this as user input 24 at the input device 22 after the selected connection line 12 has been connected and laid.

The technician can then select the next connection line from the set of pre-assembled connection lines and position its identifier in front of the camera 14, whereupon the procedure described above for the new connection line is repeated. In this way, the technician can gradually retrieve the information required for laying the individual pre-assembled connecting lines automatically, thus avoiding installation errors.

If the input device 22 collects user inputs about the connection made, in particular the wiring, of previously identified connection lines, the visualization device 6 can take this into account when generating the user output 20, for example by also displaying the already installed connection lines in the graphical representation of the switch cabinet, in order to simulate the real view of the switch cabinet and simplify the connection of the current connection line 12 for the technician.

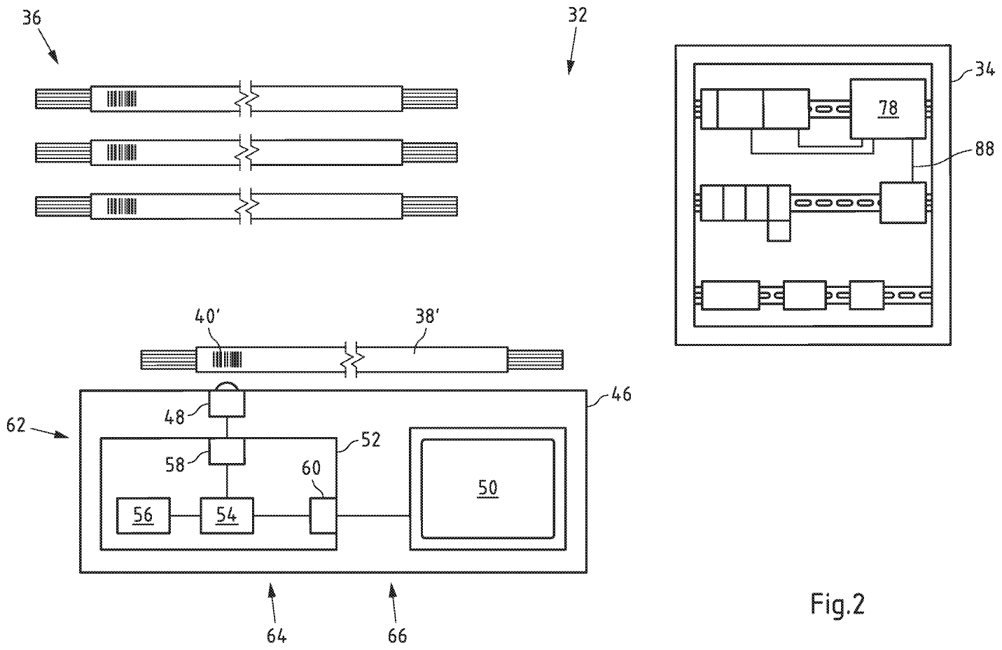

FIG. 2 shows another example of a System 32 design for the automated support of a connection process, in particular wiring process, of components arranged in a control cabinet 34 with a quantity 36 of pre-assembled connection lines 38. The connection lines 38 can, for example, be defined in advance on the basis of a virtual routing on a virtual model of the control cabinet 34 and then assembled accordingly. In this way, the necessary connecting lines 38 with the correct type and length and, if necessary, with the correct connections, are available to the technician before the connection process begins.

The individual connecting lines 38 are each printed with identifiers 40, which can be used to distinguish the connecting lines 38 from each other. Identifiers 40 are preferably used to uniquely identify the individual connecting lines 38 within the quantity 36. FIG. 2 shows identifiers 40 as barcodes. However, other identifiers are also conceivable, for example character sequences printed on the connecting lines 38.

The system 32 for supporting the connection process includes a mobile device 46, for example a smartphone or a tablet-computer, with a camera module 48, a user interface 50 in the form of a touchscreen and a controlling unit 52 with at least one processor 54 and an electronic memory 56 connected to the processor 54 as well as interfaces 58 and 64 for communicating with the camera module 48 and the touch screen 50. A computer program is saved on the memory 56 of the controlling unit 52 the execution of which on the at least one processor 54 of the controlling unit 52 triggering the execution of a method for automated support of a connection process of the components arranged in the switch cabinet 34.

The camera 48 is configured to detect image data and the controlling unit 52 is configured to analyze the image data received from the camera 48 during the execution of the computer program saved on the memory 56 in such a way that, if the data includes an identifier 40′ of the connecting line 38′ from a set 36 and if so, to generate a digital code for the identifier 40′. For this purpose, a list with the identifiers 40 of the connection lines 38 out of the set 36 can be stored on the memory 56 for example, such that the controlling unit 52 can decide by comparison of the generated code with the identifiers saved in the list, if the detected identifier 40′ belongs to the connection line 38′ from the set 36 for connecting, in particular for wiring, of the components arranged in the switch cabinet 34.

The camera 48 can be configured to permanently detect image data, and the controlling unit 52 can be configured to continuously search through the detected image data until an identifier 40′ is detected when a connection line 38′ from the set 36 is positioned in front of the camera 48. Alternatively the controlling unit 52 can also be configured to search for an identifier through an image detected by the camera 48 as a result of a user input via the touch screen 50.

The execution of the computer program saved on the memory 56 on the at least one processor 54 further causes, that depending on the detected identifier 40′ or the code generated for it a user output is generated regarding the connecting, in particular the wiring, of the connecting line 38′ identified via the identifier 40′. For this purpose, a connection plan, for example wiring plan, is saved on the memory 56, the plan including information about the connection of the connecting line 38 from the set 36. For example, the connection plan can be saved in form of a virtual model of the switch cabinet 34 which besides information about the switch cabinet, for example about its dimensions and the components arranged or to be arranged and it, also includes information about the connection points and/or about the wiring paths of the connecting lines 38. In the connection plan, the information on the individual connection lines 38 is preferably assigned to the respective associated identifier 40 of the connection line 38, so that the control device 52 can retrieve the information for the connection line 38 to be currently connected from the connection plan depending on the detected identifier 40′ or the digital code for it and use it for generating the user output.

Once the user output has been generated, the control unit 52 displays it on the touch screen 50 so that the technician receives the information he needs to connect the corresponding connection line 38 via the touch screen 50.

The camera 48 and the control means 52 together with the program part of the computer program on the memory 56 designated for detecting an identifier form detection means 62 of the system 32, the control means 52 together with the program part of the computer program on the memory 56 designated for generating a user output form visualization means 64 of the system 32, the touch screen 50 and the control means 52 together with the program part of the computer program on the memory 56 designated for outputting the user output form output means 66 of the system. Thus, the individual devices of the system need not necessarily be formed by different hardware components, but may share, for example, a common control device running a computer program with corresponding modules for the individual devices.

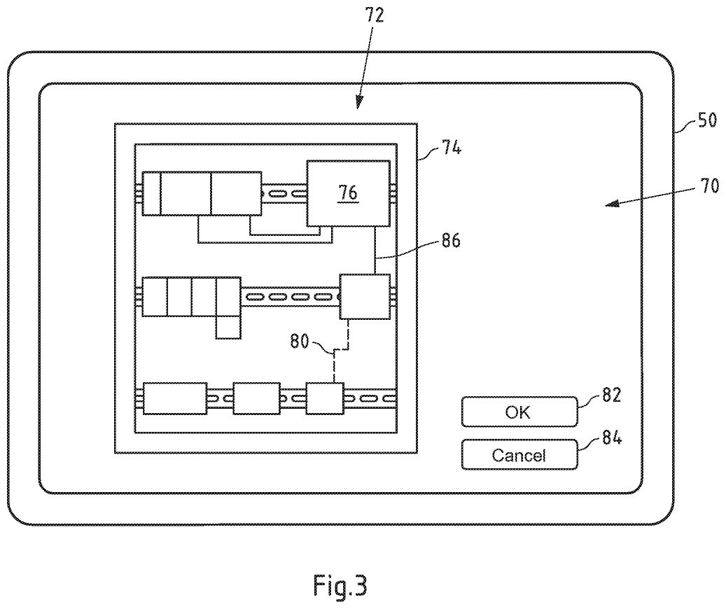

On the basis of FIG. 3 an example of a user output generated by the control unit 52 and displayed via the touch screen 50 is now explained.

FIG. 3 shows the touch screen 50 with a user output 70 displayed on it, which was generated by the control unit 52 for the connection line 38′ identified by the detected identifier 40′.

The user output 70 includes a representation 72 of switch cabinet 34, which may, for example, have been generated by a virtual model of switch cabinet 34 stored in memory 56. Representation 72 comprises a representation 74 of the switch cabinet itself as well as representations 76 of components 78 installed therein. 72 also comprises a highlighted representation 80 of the identified connecting line 38′ in the connected, e.g. wired, state, so that the technician can intuitively see from the user output 70 where, i.e. at which connection points, he has to connect the selected connecting line 38′ with the components 78 in the switch cabinet 34 and which routing path has to be selected in the switch cabinet 34. The highlighted illustration 80 with the identified connecting line 38′ in the connected state is only an example. Instead, the representation 80 could, for example, also include two arrows which indicate the position of the respective connection points of the connecting line 38′.

Alternatively or additionally, representation 72 can also include a list representation of all connection lines, whereby the identified connection line 38′ can be highlighted, for example, and information on connecting this connection line 38′ can be displayed.

Virtual buttons 82, 84 are also displayed on the touchscreen 50, allowing the user to make a user input by touching the touchscreen 50 in the area of one of the two buttons. By pressing button 82, the user can confirm that he has completed the connection of the connecting line 38′; by pressing button 84, he can cancel the operation and select another connecting line from the set 36 of connecting lines, for example.

The user's inputs via the touch screen 50 are registered by the control unit 52 and stored in the memory 56, so that the control unit 52 has the information which of the connecting lines 38 of the set 36 have already been connected. This information can be used, for example, to generate subsequent user outputs. In particular, it is conceivable that the user output 70 can also include representations 86 of previously laid connection lines 88, so that the technician of the user output 70 can intuitively see the position of the new connection line 38′ relative to the already laid connection lines 88.

The system 32 can also be configured for augmented reality representation. For this purpose, the execution of the computer program stored in the memory 56 on the at least one processor 54 preferably causes a real image of the switch cabinet 34 and the components arranged therein, captured by the camera 48, to be superimposed with a representation 80 of the identified connecting line 38′ in such a way that the representation 80 indicates the position of the connecting line 38′ in the installed state above the real image of the switch cabinet and the components arranged therein.

Instead of a touch screen 50, a simple screen can also be provided. In this case, keys such as a keyboard, a computer mouse or a touchpad can be provided for user input.

Instead of or in addition to a touchscreen 50 or a simple screen, the system can also have data glasses for outputting the user output. The data goggles can, for example, be connected to the control unit 52 via a radio link.

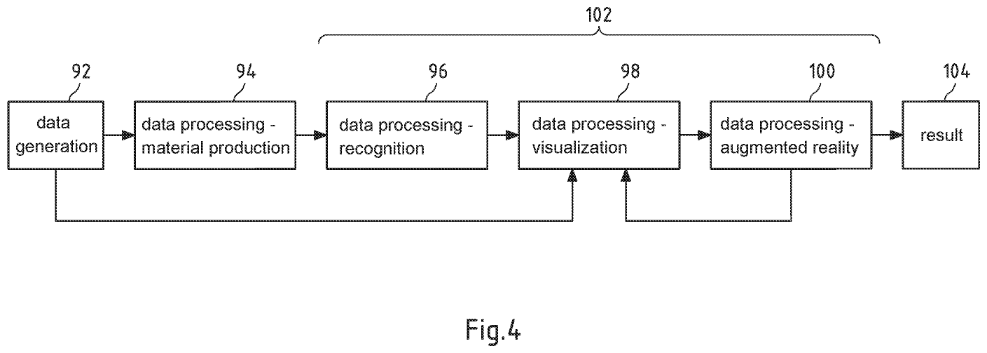

FIG. 4 shows an example of a fully digitally supported workflow from the design of a switch cabinet to the manufacture of pre-assembled connecting lines and the subsequent process of automated support for a connection process, such as a wiring process, comprising the detection of the connecting line, the interpretation of the connection, the display of a corresponding user output, and finally, as a result, the completed switch cabinet. FIG. 4 shows in particular how the method described herein and a system configured to perform the method, such as system 2 or 32, can be incorporated into such a workflow.

In the first step 92, a virtual model of the switchgear cabinet to be produced is first generated by means of a computer program provided for this purpose, by virtually equipping the virtual switchgear cabinet with the provided components and using them for connecting, in particular for wiring of the individual components with regard to their type and, if necessary, their installation routes. In this step, the connection plan for system 2 or 32 is preferably generated, which will later be used to generate the user outputs for connecting the individual connection lines.

In the next step 94, the connecting lines to be assembled are determined on the basis of the data model of the switch cabinet generated in the first step 92 and produced on this data basis. The individual connection lines are each provided with individual identifiers, for example by printing a numerical label or a barcode, which can be used to uniquely identify the individual connection lines within the set of connection lines assembled for connecting the components to be or arranged in the switch cabinet.

The following three steps 96, 98, 100 now correspond to a method for the automated support of the connection process as already described before (see parenthesis 102).

In step 96, a detection device is used to detect an identifier of a pre-assembled connecting line for the connecting, in particular the wiring, of components arranged in a switch cabinet.

In step 98, a visual user output is generated by connecting the connection line identified by the detected identifier. The visualization is carried out on the basis of the previously detected identifier specifically for the connection line identified in step 96 and depending on the connection plan preferably generated in step 92 (see arrow from step 92 to step 98), which is available, for example, in the form of a virtual model of the switch cabinet and contains information about the connection points and the routing path of the identified connection line.

In step 100, the user output generated in step 98 is provided via an output device such as a screen or data glasses. Preferably, the output is in the form of an augmented reality representation, so that the user can intuitively and spatially relate the work instructions required for the manual laying of the identified connecting line, i.e. the connection points and the laying route of the relevant connecting line, to the real switch cabinet.

Steps 96, 98 and 100 are repeated one after the other for the individual pre-assembled connecting lines until finally, in step 104, the switch cabinet with the fully connected, in particular wired, components arranged therein is completed as a result of the entire process.

Preferably, the user of the system can confirm the successful connection of the respective connection line in step 100 via an input device. This information is transmitted to the visualization device so that it can take the information about already laid connection lines into account when generating user outputs of subsequently identified connection lines (cf. arrow from step 100 to step 98).

The method for the automated support of a connection process of components arranged in a switch cabinet or on a mounting system, such as a mounting plate, can in particular also comprise the preparatory steps 92 and 94, in which the connection plan and the pre-assembled connecting lines are generated.

The entire method from step 92 to 104 is an example of a method for connecting, in particular wiring, components arranged in a switch cabinet or on a mounting system, e.g. a mounting plate. This procedure achieves a completely digitally supported workflow from the planning stage through the assembly of the connecting lines, their recognition and interpretation to the connection of the connecting lines to the components in the real switch cabinet or on the mounting system, e.g. a mounting plate.

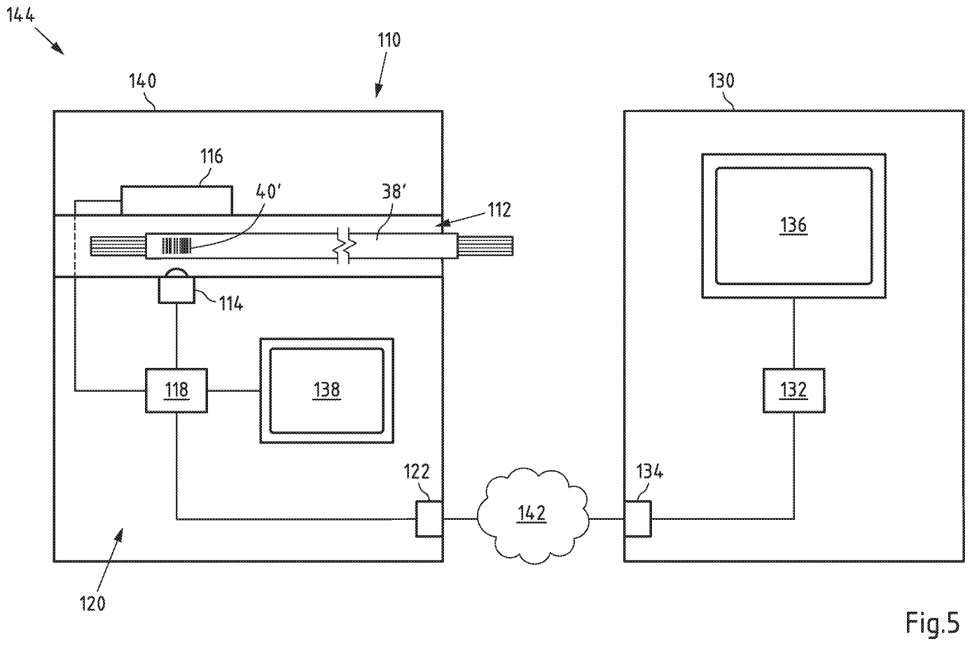

FIG. 5 shows an example of a detection unit for detecting an identifier 40′ of a connecting line 38′. The detection unit 110 comprises a receptacle 112, into which a connecting line 38′ to be identified can be inserted. In the area of the receptacle 112, a camera module 114 is arranged with which image data from a connecting line 38′ inserted into the receptacle 112 can be captured.

Receptacle 112 is designed in the form of a duct-shaped cavity open on both sides, so that the connecting line 38′ can be inserted into receptacle 112. Since the receptacle 112 is open on both sides, the connecting line 38′ can be pushed into the receptacle 112 until the identifier 40′ of the connecting line 38′ can be detected by the camera module 114. This allows the identifier 40′ to be captured regardless of its position on the connecting line 38′.

Alternatively, the receptacle 112 can also only be opened on one side, especially if the identifier 40′ is provided at a given position of the connecting line 38′, for example at a certain distance from one end of the connecting line 38′. The depth of the socket 112 is then preferably adjusted so that the identifier 40′ is located in the field of view of the camera module 114 when the connecting line 38′ is pushed into the socket 112 as far as it will go.

Receptacle 112 preferably has a shape in the form of an edge and camera module 114 is preferably arranged so that the edge lies within the field of view of camera module 114. For example, the receptacle 112 may have a triangular cross-section or be prism-shaped, with one corner of the triangle or one edge of the prism shape within the field of view of camera module 114. The edge defines a defined contact point for the connecting line 38′, which facilitates the positioning of the connecting line 38′ in the receptacle and the identifier 40′ in the field of view of the camera module 114.

The detection unit 110 also has a lighting device 116 with which the receptacle 112 can be illuminated in the area of the camera module 114, so that the identifier 40′ can be reliably detected regardless of the external lighting conditions. The lighting device 116 shall preferably extend transversely to the longitudinal extent of the receptacle 112 in such a way that at least 180° of the curved surface of a connecting line arranged in the receptacle 112 is illuminated, so that the identifier printed on the curved surface of a connecting line can be reliably detected.

The detection unit may optionally have a screen 138 on which the image captured by the camera module 114 is output to facilitate the technician's positioning of the connecting line 38′ in the receptacle 112. In particular, this makes it easier for the technician to position the identifier 40′ within the field of view of the camera module 114.

The detection unit 110 further comprises control means 118 configured to detect in the detected image data an identifier 40′ of a connection line 38′ and to generate a digital code for the detected identifier. The control unit 118 can also control the function of the camera module 114 and the lighting unit 116.

In addition, the detection unit 110 comprises transmission means 120 adapted to transmit the digital code for the found identifier 40′ to visualization means for generating a user output by connecting the connecting line identified by the identifier. The transmitting means 120 is arranged to transmit the digital code for the identifier 40′ to a server 130 comprising control means 132 on which runs a computer program for generating a visual user output depending on the digital code. Accordingly, the transmitting means 120 at the detection unit 110 formed on the one hand by a network interface 122, for example a LAN or WLAN interface, and by a part of the computer program running on the control means 118, which causes the digital code for the identifier to be transmitted to the server 130 via the network interface 122 and a network 142.

The server 130, which has a corresponding network interface 134 for receiving the digital code, can then be configured from the transmitted digital code for the 40′ identifier and a connection plan stored on a memory of the server 130, for example a virtual model of the switch cabinet with the components arranged therein to be connected, generate a user output by connecting the connecting line 38′ identified by the identifier 40′. The generated user output can then be displayed on a screen 136 of the server 130. In addition or alternatively, the user output may also be output via data goggles coupled to the server 130 or to the detection unit 110 via a wired or wireless communication link.

In addition, it is also conceivable that the generated user output is transmitted from the server 130 to the detection unit 110 and output via an optionally provided screen 138 of the detection unit 110.

The detection unit 110 and the server 130 together form a system 144 for the automated support of a connection process of components arranged in a switch cabinet or on a mounting system, e.g. a mounting plate.

As an alternative to generating the user output on the server 130, the user output can also be generated in the detection unit 110 itself. For example, the controller 118 may be arranged to generate a user output depending on the generated code for the identifier 40′ and a connection plan stored in a memory of the controller 118 and to output it, e.g. via the screen 138 of the detection unit 110 or via data goggles connected to it via a communication link. In this case, the control device 118 with a part of the computer program running on it for generating the user output represents the visualization device. In this case, the digital code is transmitted to the visualization device purely by software, whereby the control device and a corresponding program part represent the transmission device.

The detection unit 110 is configured as a stationary device which can be set up at the place of use near the switch cabinet to be connected. For protection against adverse environmental conditions, such as dust or moisture, the detection unit 110 preferably comprises a suitable enclosure 140 in which the individual components of the detection unit 110 are housed.

From the above description of examples of the system, the detection unit, their uses, the method and the computer program, it is apparent that these enable automated support of the connection process of components arranged in a switch cabinet or on an assembly system in such a way that misconnections are avoided, since the performing technician intuitively provides the information required for the connection of the individual prefabricated connection lines via the user output and can implement them.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-15. (canceled)

16. A method for the automated support of a connection process, in particular of a wiring process, of components arranged in a switch cabinet,
in which an identifier of a connecting line is detected from a set of pre-assembled connecting lines for connecting, in particular for wiring, components arranged in a switch cabinet by means of a detection device, wherein the identifier identifies the connecting line,
in which a visual user output is automatically generated depending on the detected identifier and a connection plan, in particular a wiring plan, the visual user output concerning the connecting, in particular concerning the wiring, of the connecting line identified by the identifier and
in which the generated user output is delivered via an output device, wherein the generating of the visual user output includes generating a graphical depiction of the connection points and the laying route of the connecting line.

17. The method according to claim 16,
wherein the user output is generated by means of a virtual model of the switch cabinet with a depiction of the connecting, in particular the wiring, of the identified connecting line.

18. The method according to claim 16,
wherein the user output is delivered via an augmented reality device, in particular a screen or data glasses, wherein a real image or a real object is superimposed with the generated user output.

19. The method according to claim 16,
in which a user input is received concerning the completed connecting, in particular concerning the completed wiring, of another connecting line identified at an earlier point in time, and
in which the user output is generated concerning the connecting, in particular concerning the wiring, of the identified connecting line depending on the user input concerning the completed connecting, in particular via the completed wiring, of the other connecting line.

20. A system for the automated support of a connection process, in particular a wiring process, of components arranged in a switch cabinet, in particular for carrying out a process in accordance with claim 16,
having a detection device configured to detect an identifier of a connecting line, wherein the identifier identifies the connecting line,
having a visualization device which is configured to generate a visual user output depending on the detected identifier and a connection plan, in particular a wiring plan, concerning the connecting, in particular concerning the wiring, of the identified connection line, and
having an output device configured to deliver the user output generated by the visualization device to a user, further comprising a set of pre-assembled connecting lines for connecting, in particular for wiring, of components arranged in the switch cabinet, wherein each connecting line has an identifier for identifying the respective connecting line, wherein the visual user output includes a graphical depiction of the connection points and the laying route of the connecting line.

21. The system according to claim 20,
wherein the visualization device is arranged to generate the user output by means of a virtual model of the switch cabinet a visualized user output with a depiction of the connection, in particular the wiring of the identified connecting line.

22. The system according to claim 20,
comprising an augmented reality device configured to deliver the user output to a user, wherein a real image or a real object is superimposed with the generated user output.

23. The system according to claim 20,
further comprising an input device configured to receive user inputs concerning the completed connecting, in particular the completed wiring, of previously identified connecting lines,
wherein the visualization device is configured to generate the user output concerning the connecting, in particular concerning the wiring, of an identified connecting line depending on user inputs concerning the completed connecting, in particular the completed wiring of other, previously identified connecting lines.

24. The system according to claim 20, further comprising a controlling device configured to effect execution of a method for the automated support of a connection process, in particular of a wiring process, of components arranged in a switch cabinet,
in which an identifier of a connecting line is detected from a set of pre-assembled connecting lines for connecting, in particular for wiring, components arranged in a switch cabinet by means of a detection device, wherein the identifier identifies the connecting line,
in which a visual user output is automatically generated depending on the detected identifier and a connection plan, in particular a wiring plan, the visual user output concerning the connecting, in particular concerning the wiring, of the connecting line identified by the identifier and
in which the generated user output is delivered via an output device, wherein the generating of the visual user output includes generating a graphical depiction of the connection points and the laying route of the connecting line.

25. Use of a system according to claim 20 for the automated support of a wiring process of components arranged in a switch cabinet.

26. A computer program comprising program instructions whose execution on at least one processor causes a method to be executed in accordance with claim 16.
